(19) United States
(12) Patent Application Publication
(10) Pub. No.: US 2013/0214503 A1
(43) Pub. Date: Aug. 22, 2013

(54) Devices To Let A Tilting Vehicle Lean When Driving And To Keep It Standing When Stopped

(71) Applicant: Giovanni Antonio Chiuppani, Rosa (IT)

(72) Inventor: Giovanni Antonio Chiuppani, Rosa (IT)

(73) Assignee: Dastrada Srl, Rosa (IT)

(21) Appl. No.: 13/883,211

(22) PCT Filed: Jan. 2, 2012
(86) PCT No.: PCT/IB12/00001

§ 371 Date: May 2, 2013

(30) Foreign Application Priority Data
Nov. 2, 2010 (IT) TV2010A000144

(51) Int. Cl. B62K 5/10

(52) U.S. Cl. CPC B62K 5/10
USPC 280/124.103

(57) ABSTRACT

Tilting devices suitable to vehicles that are free to tilt and free to be steered, apt to let them lean when driving and to keep them standing when stopped only by means of their brakes (or the like) (61, 62), characterized in that, due to a suitable tilt axis inclination with reference to the ground and to a proper combination and proportion of parts, any lateral rotation of the tilting vehicle around its tilt axis (at) is kinematically linked to a differential longitudinal displacement (fdd) of at least two wheels (wh1, wh2) (or endless tracks, snow skis, ice skates, or the like), in a way that the tilting vehicle can effectively be kept standing when stopped and can be parked perpendicular to the ground and crosswise a slope of at least 15% by simply operating the vehicle's brakes (or the like) (61, 62) and without further locking devices.

### TECHNICAL FIELD

The inventive concept relates to the field of transportation, specifically to the field of narrow vehicles that can lean by side so that the gravitational force can balance the centrifugal force when cornering. It is mostly applicable to the field of road tilting vehicles but it can however be conveniently applied also to other tilting vehicles moving on tracks, skis, skates, and the like.

### GLOSSARY

Due to the relative novelty of the field, it seems useful to specify the meaning of some terms used hereinafter:

The term “ground” is used to indicate any surface made of any substance of any consistency but characterized in that a vehicle can usually be moved over it and can be braked, wherein said substances can be: concrete, asphalt, soil, lawn, gravel, sand, ice, snow, and the like.

The term “footprint” or “contact area” of a vehicle on the ground is used to indicate the closed surfaces where said vehicle and the ground transmit each other their contact forces

The term “wheel” is used to indicate the devices which support the vehicle over the ground and which let the vehicle move efficiently, said wheels being characterized in that they leave a substantially continuous track on the ground—hereinafter named “ground track”—while the vehicle moves. More specifically the term “wheel” is used to indicate either the usual disc-shaped wheels with a rotational symmetry axis or the endless tracks, snow skis, ice skates, and the like

The term “vehicle” is used to indicate all the vehicles which can move on said ground by mean of said wheels, including motor vehicles, rail vehicles, motorcycles, cycles, hand carts, sledges and the like.

The term “single track vehicle” is used to indicate a vehicle that leaves a single ground track as it moves forward.

The term “symmetry plane” of the vehicle is used to indicate the longitudinal plane belonging to a vehicle, against which, when the tilting vehicle is perpendicular to the ground, the wheels and other vehicle's masses are arranged substantially symmetrically.

The term “perpendicular to the ground” is used to describe the tilting vehicle when it is on the ground with its symmetry plane perpendicular to the ground.

The term “vertical” or “vertical position” is used to describe the tilting vehicle when it is on the ground in a position that maximizes the potential energy of its center of mass.

The terms “symmetric wheels” and “symmetric footprints” is used to describe the wheels and footprints when they are arranged substantially symmetrically with respect to the symmetry plane of the vehicle. The terms “inner wheels” and “inner footprints” are used to indicate the wheels and footprints on the inner side of the curvature of the vehicle's trajectory, and vice-versa for “outer wheels” and “outer footprints”.

The verb “to roll”, the substantive “roll” and the adjective “rolling” are used to describe the generic rotation of a vehicle around a longitudinal axis; hereinafter the roll is described as “elastic roll” or “resilient roll” when it is solely due respectively to the elastic or resilient deflection of the wheels' suspensions.

The verbs “to tilt”, “to lean” and “to bank” will be taken as synonyms, as well as the substantive “tilt”, “lean” and “bank” and the corresponding adjectives “tiltable”, “leanable” and “bankable”. These terms are used mainly to describe the lateral rotation of the vehicle around a “vehicle tilt axis” (defined in the followings), when the elastic roll is prevented. Said lateral rotation is called also “tilting” or “leaning” or “banking”.

The terms “tilt angle”, “bank angle”, “lean angle” are used interchangeably to indicate the angle of lateral inclination between the symmetry plane of the tilting vehicle and the perpendicular to the ground, in the case that the elastic roll is prevented. The component of the angle of roll of the tilting vehicle, which is solely due to the deflection of the elastic suspensions of its wheels, is called “elastic roll angle”.

The term “effective tilt angle” is used to indicate the angle between the vector of the net force applied to the centre of mass of the vehicle, when cornering at constant speed on a level ground, and the plane perpendicular to the level ground which maximizes said effective tilt angle. Usually the tilt angle and the effective tilt angle do not coincide.

The term “tilting vehicle” is used to indicate the vehicles which leave three or more not aligned footprints on the ground and which, referring to a line perpendicular to the ground, are laterally tiltable by means of suitable devices: these vehicles are also known as “leaning vehicles”, “banking vehicles”, “tiltable vehicles” or “leanable vehicles” or the like. More specifically the term “tilting vehicle” is hereinafter used to indicate those vehicles that can be tilted to the main purpose of fully counteracting the centrifugal force while cornering at least under the lateral acceleration normally expected while driving, that is approximately 0.5 g, magnitude which approximately correspond to a tilt angle of 25 deg.

More precisely, the tilting vehicles are named “tilting three wheeler” when the wheels are three, two of which are substantially symmetrically arranged with respect to the symmetry plane of the vehicle, and “tilting four wheeler” when the wheels are substantially symmetrically arranged in pairs with respect to the symmetry plane of the vehicle.

The term “tilting device” is used to indicate the device that directly achieves the tilt of the vehicle by converting into a sideways rotation of the vehicle the relative movement of its wheels. More specifically a tilting device is named “tilting mechanism” when it is mainly made up of mechanical elements whilst the term “tilting hydraulic device” is used to indicate a device in which fluids in motion are used to make the vehicle tilt.

The term “tilt system” is used to indicate the set of elements that perform the tilting; more specifically a tilt system is named “tilt mechanism” when these elements are mostly mechanical.

The term “forced tilt system” is used to indicate a system able to force the tilting by means of actions that are internal to the tilting vehicle.

The term “tilt control device” and “tilt control system” are used to indicate respectively a device and a system apt to control the tilt of the vehicle.

Referring to the control of the tilting, the term “dynamically controlled” is used to describe a tilting vehicle in which, while driving, the tilting is controlled mainly by the pilot's will and action, and mainly through the gravitational and the dynamic reaction forces exerted on the vehicle; the term “semi automatically controlled” is used to describe a tilting vehicle in which the tilting is controlled mainly by the pilot's will and actions, and also by means of servomechanisms; the term “automatically controlled” is used to describe a tilting vehicle in which the tilting is controlled mainly by a system that automatically enacts the will of the pilot.

The terms “free to tilt”, “free to lean”, “free to bank” or “free tilting vehicles”, “free leaning vehicle” or “free banking vehicles” are used interchangeably to describe the tilting vehicles that are dynamically controlled while driving and that, when stopped, are free to fall sideways whenever their lateral rotation around the vehicle tilt axis is not prevented by any means. Are not included in this category the tilting vehicles in which the tilting can be controlled by acting on the steering handlebar or steering wheel. Vehicles free to tilt are also necessarily free to be steered.

The terms “tilt axis” and “tilt axes” are used to indicate the single or multiple axes of rotation, with respect to the vehicle or to an interposed suspension, of the tilting device or of its subsystems. The tilt axis is immediately identified in axles which are pivotally connected to the vehicle's chassis or to a suspension device; differently, in tilt systems with multiple axes of rotation, or with transverse axes, the term “tilt axis” is used to indicate an equivalent formal single tilt axis lying on the symmetry plane of the tilting vehicle, passing through the roll center of the correlative axle and characterized in having, when the tilting vehicle is perpendicular to the ground, the same magnitude of the derivative dfdd/dro (where fdd is the differential displacement of the footprints of the wheels on the ground and “ro” is the vehicle tilt axis rotation) of the correlative real axle. When the tilting vehicle is leaned, the tilt axis will be named “instantaneous tilt axis”.

The term “ tilt axis inclination” or “tilt axis incidence” is used to indicate the angle between the tilt axes and the ground; the inclination is measured referring to the ground and it is taken positive and described as “forward” when the direction of the tilt axes is front-low and rear-high; vice versa it is taken negative and described as “backward”. Unless otherwise specified the magnitude, in degrees, is measured while said tilting vehicle is standing on a horizontal ground and hereinafter it will be named betaf when relating to the tilt axis at the front and betar when relating to the tilt axis at the rear. When the tilting vehicle is leaning, said tilt axis inclination will be named “instantaneous tilt axis inclination”.

The term “tilt axis rotation” is used to indicate the rotation around the single or multiple tilt axes of the tilting device or of its subsystems.

The term “trail of the tilt axis” is used to indicate the distance between the point of incidence on the ground of the tilt axis and the line passing through the centres of the nearby symmetric footprints; this distance is taken as positive when the said point of incidence is in front of said line. As per the tilt axis, unless otherwise specified, the measurement of said trail is taken when the tilting vehicle is perpendicular to the ground. When the tilting vehicle is leaned, said trail will be named “instantaneous trail of the tilt axis”.

The term “tilt axis moment” is used to indicate the component of the moment transmitted by the tilt mechanism to the vehicle and viceversa in the direction of the tilt axis

The term “vehicle tilt axis” is used to indicate the axis of the lateral rotation of the tilting vehicle with respect to the ground. The vehicle tilt axis usually lies on the symmetry plane of the tilting vehicle. When the tilting vehicle is leaned, said vehicle tilt axis will be named “instantaneous vehicle tilt axis”.

The term “vehicle tilt axis inclination” or “vehicle tilt axis incidence” is used to indicate the angle between the vehicle tilt axis and the ground; the inclination is considered positive when the direction of the vehicle tilt axis is rear-high/ front-low. The position of the vehicle tilt axis is a spatial function of the tilt angle of the vehicle, which depends also on the kinematics of the tilting device: therefore, unless otherwise specified, said vehicle tilt axis inclination is related to the tilting vehicle perpendicular to the ground. When the vehicle is leaned, said vehicle tilt axis inclination will be named “instantaneous vehicle tilt axis inclination”.

The term “vehicle tilt axis rotation” is used to indicate the rotation of the vehicle around its tilt axis, measured by the tilt angle, and called also “tilting” or “leaning” or “banking”.

The term “vehicle tilt moment” is used to indicate the component of a moment which acts on the tilting vehicle in the direction of the vehicle tilt axis

The term “differential displacement” of two footprints of the tilting vehicle is used to indicate the displacement on the ground of one wheel's footprints against the other. Such movement is kinematically connected to the rotation of the tilting vehicle around its tilt axis through the tilting device.

The term “steering” by itself is used to indicate the action of steering

The term “steerable”, is used to describe a device capable of being steered; The term “steerable wheel”, is used to indicate a wheel pivoted so that it can be individually steered;

The term “steering axle” is used to indicate an axle carrying at each end two steerable wheels which are pivotally connected by means of a steering linkage; the axle can be a rigid member or a linkage, such as a four bar linkage, or the like

The term “pivoted axle” is used to indicate an axle that is pivotally connected to the chassis of the vehicle or to an interposed suspension, where the axis of the pivot coincides with the steering axis and lies on the symmetry plane of the vehicle, said pivoted axle is also carrying at least two opposite not steerable wheels rotatably connected at its ends;

The term “steering axis”, unless otherwise specified, is used to indicate an axis around which a wheel or a pivoted axle can be steered;

The term “steering angle”, unless otherwise specified, is used to indicate an angle of rotation of a steerable wheel or a pivoted axle from the position of said steerable wheel or pivoted axle at which the vehicle goes straight ahead.

The term “steering torque”, unless otherwise specified, is used to indicate the component of the torque that acts on the steerable wheel in the direction of the steering axis.

The terms “steering connected to the tilting” and “tilting connected to the steering” are used with reference to tilting vehicles in which there is a correspondence between steering angle and tilting angle.

The term “biunique” is used to describe the “steering connected to the tilting” and the “tilting connected to the steering”, referring to tilting vehicles in which there is a biunique correspondence between the steering angle and tilting angle so that at each tilt angle is associated just one steering angle and vice-versa.

The term “free to be steered” is used to describe tilting vehicles characterized by the absence of any correspondence between steering angle and tilt angle of the vehicle.

The term “standing” is used to indicate the act of keeping the tilting vehicle in a vertical position when stopped or parked, where “vertical” describes the direction of the gravitational force.

The term “stand device” or “verticalization device” is used to indicate the device apt to keep the tilting vehicle in an vertical position, without falling sideways, when the vehicle is stopped or parked. More specifically the term “forced verticalization device” is used to indicate a verticalization device also apt to force the tilt of the vehicle towards the vertical position.

The term “standing system” or “verticalization system” is used to indicate the set of all the elements that perform the verticalization.

The term “tilt locking device” and “tilt brake” are used to indicate respectively stand devices apt to lock the tilting device or to brake it, so as to prevent the lateral rotation of the tilting vehicle.

The term “standing tilt moment” is used to indicate the conventional reaction moment around the vehicle tilt axis that can be provided by the stand device to keep a free tilting vehicle safely parked without falling sideways. Said standing tilt moment counteract the moment, around the vehicle tilt axis, of the external actions that, when the tilting vehicle is parked, can impair its balance therefore causing its sideways fall. These can be, for instance, the moment around said vehicle tilt axis due to the vehicle's weight in case of defective vertical position of the tilting vehicle, or to incidental side pushes, lateral blasts of wind, and the like. Hereinafter the magnitude of said standing tilt moment is conventionally assumed equal to the moment around the vehicle tilt axis solely due to the vehicle's weight when said vehicle is parked perpendicular to a ground and crosswise a slope of at least 15%, to the limit of the sideways fall. Said conventional cross slope is hereinafter named “maximum parking slope” (shortly: mps %).

Referring to the control of the stand devices: the term “manually controlled” is used to describe a device to make the vehicle standing only by the pilot's will and direct action; the term “semi automatically controlled” is used to describe a device which is controlled by the pilot's will and by means of servomechanisms; the term “automatically controlled” is used to describe a device which is controlled mainly by a control system that automatically enacts the will of the driver.

The term “tilt/stand device” is used to indicate a tilting device which can work as stand device through other vehicle's basic operations, such as braking.

Referring to the vehicle's suspension of each axle, the term “suspension in parallel” to the tilting device is used to describe a suspensions' layout such that each wheel of the same axle can independently move, relative to the chassis, even when the tilting is locked; conversely, the suspensions' layout is described with the term “suspension in series” to the tilting device.

with reference to the dynamic behavior of the vehicle, the term “driveability” is used to indicate the ability of a vehicle to react promptly and accurately to the input of the driver, for instance when suddenly cornering, aiming to follow a precise trajectory.

The term “maneuverability” is used to indicate the easiness of making the vehicle change its trajectory, so that a vehicle is considered more manoeuvrable when it can be driven at higher speed along an assigned curvilinear path and/or in avoiding a sudden obstacle.

The term “handling” is used to indicate the ease of driving a vehicle by an inexperienced rider.

The opposite term “stability” is used to indicate the ability of a vehicle in resuming the initial trajectory after a sudden diversion and/or in keeping on its trajectory despite disturbances

The term “fail-safe” is used to describe components, devices or systems which, in case of damage, do not cause danger to the safety of people.

The term “fail-secure” is used to describe components, devices or systems which, in case of damage, do not cause improper running of the system.

The term “safe-life” is used to describe components, devices or systems whose life is a function of their oversize and/or redundancy.

The attribute “ffw”, which stands for “feet forward”, is used to indicate vehicles with a car-like driving position, that is with feet ahead the seat. The attribute “fbl”, which stands for “feet below”, is used to indicate vehicles with a bike-like driving position, that is with feet below the seat.

### BACKGROUND ART

The risk of rollover of vehicles due to the centrifugal force in a bend is a well known problem, particularly in vehicles that are narrow and have a relatively high centre of mass.

The vehicles that leave a single ground track when moving forward, such as the bicycles, motorcycles and the like, have universally proved that, by properly tilting them, the centrifugal force can be balanced by the force of gravity. In order to combine the narrowness and the driveability of the single track vehicles with the road-holding and the capability of standing when stopped of the traditional vehicles on three and four wheels, many types of new tilting vehicles have been disclosed.

For reasons of simplicity, lightness and reliability, most of said tilting vehicles are free to tilt, that is they tend to fall sideways when stopped.

So far, the problem of keeping the free tilting vehicles in a stable vertical position when stopped, has been partially solved either by simply supporting them with central stands or kickstands, as in motorcycles, or by means of specific devices added to the tilting devices for the purpose of locking or braking the tilt mechanism, so that to prevent its rotation around the tilt axis. In any case, up to now all the known stand devices are means that must be added to the tilting vehicles and that must be manually, semiautomatically or automatically controlled.

Said known added stand devices increase not only the weight, complexity and costs of the free tilting vehicles, but also the risk of dangerous failures or of human errors, whilst none of the devices known so far achieves the objectives of the devices as hereinafter claimed.

In an attempt to disclose the information that appear relevant to the patentability of the devices as hereinafter claimed, a tabulation is provided (FIG. 9) where some significant patents have been listed following the criterion that all the teachings in the prior art must be considered to the extent that they are in analogous arts, within the field of applicant's endeavor.

To this purpose, and to restrict the comparison to the most comparable solutions within the large number of tilting vehicles disclosed up to now, said tabulation refers only to the tilting vehicles that are free to tilt and free to be steered, that is to “free tilting vehicles”. Moreover it refers only to patent applications that include at least some drawings or descriptions from which a person of ordinary skill in the art can gather information pertinent to the devices as hereinafter claimed, such as for instance: the layout and design of the tilting vehicle and of its tilting device, its stand device and its wheels' suspensions, where provided, the tilt axis incidence and direction, the ratio between the track and the height of the centre of mass of the claimed vehicles.

Since, to be effective, as outlined in the following, the claimed devices necessarily involve a tilt axis incidence noticeably not null, therefore said tabulation lists only devices in which the tilt axis incidence (betaf, betar) is substantially not null. Moreover said tabulation does not list previous solutions which are functionally different from the claimed devices, for instance those solutions which apply to vehicles that are not free to tilt and not free to be steered. Therefore said tabulation does not include references concerning tilting vehicles in which the steering and tilting are connected, neither directly nor by means of actuators and/or adaptive devices; nor said tabulation includes references concerning tilting vehicles that are not free to tilt but which lean by means of servoactuators suitably governed; neither are included the tilting vehicles in which the tilting is controlled by the driver acting on the steering handlebar or steering wheel.

More specifically among said information, the tabulation in FIG. 9 quotes: the tilt axis incidence (in degrees) and its direction (“+” when forward, that is from rear-high to front-low, otherwise “−”), the position of the tilting devices (“front”, “rear”, “middle”, where the tilting device engage respectively the front axle, the rear axle or the front and rear parts of a splitted vehicle's chassis), the number of tilting wheels (followed by the letter “T”) and the number and position of steering wheels (“1F”, “2F” where “F” is to say “front”), the layout of the wheels' suspensions if any (in “parallel” or in “series”, shortened respectively as “par” and “ser”).

Where inferable from the patent's claims, drawings or description, said tabulation quotes also the driving posture in the free tilting vehicles relative to the position of the driver's feet related to the seat (feet forward, shortened “ffw”, or feet below, shortened “fbl”); the tabulation quotes also the ratio “hg/ft” between the height of the centre of mass “hg” of the free tilting vehicle and the track “ft” of the axle pertinent to the tilting device.

Said tabulation quotes also the working principle of the stand device (mechanical by means of a brake, mechanical by means of an harpoon or hydraulic by means of a valve, respectively shortened as “mbr”, “mhr”, “hdv”) and of its control (manual, semiautomatic or automatic, respectively shortened as “man”, “sau”, “aut”). Said working principle has been specified only when provided in the patent's claims, drawings or description

Referring to the tilting vehicle's layout, on the basis of the background art known so far, it can be said that the patented devices listed in the tabulation have been applied mostly to tilting three wheelers, the older ones with 2 rear wheels, the latter with 2 front wheels. Among said three wheelers with two wheels at the rear (shortened “1F”), are known so far the models: BSA Ariel Three, Daihatsu Hallo, Honda Gyro/Canopy (with one wheel at front that is the sole tilting wheel, shortened as “1T1F”, which refers to the same patent U.S. Pat. No. 4,356,876, with manual lock of the stand device, further improved with patent U.S. Pat. No. 4,448,436A); Xingyue (which also refers to the said U.S. Pat. No. 4,356,876); Brinkdynamics Carver (with one wheel at front that is the sole tilting wheel, shortened as “1T1F”, and with verticalization by means of electrohydraulic actuators, not listed in said tabulation as it is not a free to tilt device, refers to patent WO9914099 and others); tilting delta trikes (refer to US2002047245 and others, not listed as they are not free to tilt). Among said three wheelers with two wheels at the front (shortened “2F”), are known so far the models: Piaggio MP3 and Gilera Fuoco (where all the three wheels are tilting, shortened “3T2F”; they can stand by means of a semiautomatic electrohydraulic locking both of the front suspension and tilting device; refer to patent EP1561612); Quadro 350D (similarly shortened “3T2F”; it refers to WO2010015986 and has manual lock of the stand device); Brudeli (similarly shortened “3T2F”; it refers to US2007176384 not listed as tilt axis incidence is substantially null); some tilting tadpole tricycles (U.S. Pat. No. 4,903,857 and others, not listed as they are not free to tilt).

Other prototypes of vehicles free to tilt have been developed and disclosed by major industries in their sector, for instance: Aprilia (three wheels, all tilting, two at front, shortened “3T2F”; WO0192084), General Motors (one tilting wheel at front, two at rear, not tilting, shortened “1T1F”; GB2082987A), Mercedes (three wheels, all tilting, two at front, shortened “3T2F”; U.S. Pat. No. 5,765,846 not listed as not free to tilt), Peugeot (similarly shortened “3T2F”; EP1180476), Yamaha (four wheels, all tilting, shortened “4T2F”; JP2010143474, not listed as the equivalent tilt axis incidence is substantially null).

Based on the information available so far, it can be said that the inventors, industry and trade have far more focused their attention to the tilting vehicles for road use which are free to tilt and to be steered, and which have been produced in quantities hundreds time larger than the vehicles in which the tilting and steering are connected and all other tilting vehicles.

Referring to the free tilting devices listed in the tabulation in FIG. 9, on the basis of the background art available so far it can be said that:
free tilting vehicles are known with a noticeable tilt axis inclination, and therefore with some longitudinal differential movement of the wheels linked to tilting (patent n. EP1180476, Doveri, Piaggio, ecc); nevertheless, as known so far, none of said free tilting vehicles, neither the ones that have been widely industrialized, can take advantage from this feature to the purpose of standing the free tilting vehicles just by braking them; conversely, to said purpose, all the known tilting vehicles must implement further stand devices, therefore increasing costs, weight and risk factors of said vehicles;
free tilting vehicles are known in which: the tilt axis has a forward or rearward inclination, the tilting device is connected to the front or to the rear axle, the suspension of said axle is in series rather than in parallel to the tilting device, the ratio between the track “ft” and the height of the centre of mass “hg” is high or low, the driver's position is “feet forward” or “feet below”, but the background art disclosed so far has never taken these known features, or their combinations, as effective to the purpose of standing just by braking.

Moreover, referring to the stand devices, on the basis of the background art available so far, it can be said that:
in free tilting vehicles, such as in motorcycles and bicycles, the standing can be simply achieved with a centre or side stand, that is by means of mechanisms that counteract the sideways fall with reaction forces that are external to the free tilting vehicle and substantially vertical;
in free tilting vehicles the standing can also be achieved by braking or locking a suitable kinematic element of the tilt mechanisms against the tilting vehicle, or by closing a flow control valve in a suitable hydraulic circuit; that is the sideways fall of a free tilting vehicle can be counteracted by means of actions internal to it, and more precisely by means of friction or contact forces or by means of forces between solids and fluids (patent n. WO2010015986 claims 6, FIG. 2, not listed as the equivalent tilt axis incidence is substantially null; WO02068228 abstract, FIG. 2 and the like, not listed as not measurable);
unfortunately said stand devices increase the weight, complexity and costs, and introduce worrisome risk factors, so reducing the effectiveness of the free tilting vehicles; for instance, since the systems that control said braking or locking are made of mechanical and/or hydraulic, electrical and electronics parts, many of which have a “safe life” reliability, therefore the failure of an element of said systems, might prevent the dynamic equilibrium of the tilting vehicle, an event that would be unacceptably dangerous while driving.

So far the background art prove that the standing of the free tilting vehicles has been pursued only by adding further devices notwithstanding their worrisome risk factors for safeness and their high costs too, as if there was no reasonable expectation of success or even if there was a technical prejudice against the possibility to actually achieve said standing without adding any stand device but only by a suitable design and combination of known parts of the tilting vehicle.

Indeed the back ground art has never given so far any teaching, suggestion, or motivation to combine or modify the teachings of the prior art to produce the devices as hereinafter claimed; moreover, to my knowledge, none specific design and combination of known parts has never been disclosed, neither suggested, nor whether expressed or implied, such that, in a tilting vehicle free to tilt and to be steered, where said known parts are suitably designed and combined, an effective standing of said free tilting vehicle can be performed by means of the tilting device only, just operating the vehicle's brakes when at stops.

### DISCLOSURE OF INVENTION

### The Technical Problem to be Solved

Both the prior art and the experience highlight the usefulness of improving the free tilting vehicles in terms of safeness, reliability, simpleness, lightness, low cost of the stand and tilting devices, and in terms of driveability, maneuverability, safeness, energy efficiency of the tilting vehicles.

It is an object of the claimed devices to solve the problem of ensuring a steady standing of the free tilting vehicles, when stopped, with a low risk of a sideways fall; to this purpose it is a further object of the claimed devices to solve this problem without parts to be added to the tilting vehicles but preferably disclosing new combinations of known parts apt to make the tilting device able to perform also as a stand device.

A further object of the claimed devices is to solve the problem of lowering complexity, weight, costs, while enhancing reliability and safeness of the free tilting vehicles.

Another object of the claimed devices is to solve the problem of making the free tilting vehicles stand steadily with a manoeuvre as instinctive as (the) braking and with tilting devices safe and reliable as the vehicles' braking systems of any road vehicle.

A further object of the claimed devices is to improve driveability and maneuverability of the tilting vehicles, taking advantage of the ground forces that act on the footprints of the wheels, or the like.

### The technical solution

By a design approach based on the typological classification of the tilting and stand devices, a group of common solutions to the problems set out in the previous paragraphs can be recognized in the form of a group of tilting devices that can act as stand devices.

To this end said classification can be carried out referring to those technical features that are common both to the tilting devices and to the stand devices and that, at the same time, are apt to characterize the contribution made over the prior art by the devices as hereinafter claimed.

To identify such common technical features, attention can be focused on those features that affect the main objective of the free tilting vehicles, namely the improvement of the driveability and maneuverability compared to non tilting vehicles.

Indeed the driveability and maneuverability rely on the ability of a free tilting vehicle to react promptly, accurately and easily to the control actions of the driver, for instance when suddenly cornering. In such a case, since the cornering imply twice a change in the lean angle, forth and back, the actions exerted by the driver must be converted into a four phases change of the angular momentum around the vehicle tilt axis. To this purpose a changing moment around said tilt axis is required which in turn requires the action of suitable external forces and of a mechanism apt to convert said external forces into moments around said vehicle tilt axis.

On these premises, for the purpose of said classification, among the actions, forces, moments, momentum, geometries, physical quantities that can be taken into account, the quantities that can be common to the tilting and stand devices have to be identified.

Referring to the stand devices, since they are devices apt to prevent the sideways fall of the free tilting vehicles when standing, then, the choice among the quantities suitable for a classification, can be narrowed to those which are usually involved when a movement has to be prevented. On a first-level classification said quantities can be differentiated according to their points of application, which, on a large scale, can be “internal” to the vehicle (when forces are exerted between different parts of the vehicle), or “external” (when said forces are between the vehicle and its environment: the ground and the atmosphere). Secondly said forces can be further differentiated according to the way they physically act, for instance as normal forces, frictional forces or forces between solids and fluids.

On this premises, six different families of stand devices can be identified, characterized in that the tilting can be locked respectively by means of: “external normal forces” (ExNF), “internal friction forces” (InFr), “internal normal forces” (InNF), “internal forces between solids and fluids” (InPr), and “external friction forces” (ExFr) or “external forces between solids and fluids (ExPr).

Known examples of the first four families of stand devices are: the central stands (ExNF), very common on motorcycles; the brakes (InFr) or the harpoons (InNF) that are very often implemented in the known tilting devices to lock their rotation relative to the vehicle's chassis; the valves used to trap the fluid (InPr) in the possible hydraulic connections between suitable parts of the tilting device or between the tilting device and the chassis of the vehicle.

As for the last two families (ExFr and ExPr), no group of such stand devices has been disclosed so far. More in detail no group of stand devices has been yet disclosed characterized in that the sideways fall of the free tilting vehicles can be actually prevented, when stopped, by suitable external friction forces only.

Referring to the tilting devices, they are devices apt to let the free tilting vehicles to tilt, to the purpose of improving the driveability and maneuverability. To this purpose, inter alia, the tilting devices should improve the ability to change and keep promptly, accurately and easily the linear and angular momenta which are associated to the trajectories of the free tilting vehicles.

To this end, starting from voluntary actions of the driver, carried out by means of the handlebars, brake lever, foot controls, weight transfer, and the like, the tilting devices have to manage suitable vector quantities such as, for instance, the weight, centrifugal forces, reaction forces at the ground, linear and angular momenta.

More specifically the reaction forces at the ground act through the footprints with the components: (Rn) normal to the ground (such as the reactions to weight) and (Rp) parallel to the ground, which in turn can be resolved in the components (Rt) tangent to the vehicle's path (such as the longitudinal friction forces at the footprint due to braking) and (Rc) perpendicular to the direction of the vehicle path (such as the centripetal actions into turns and the transverse friction forces due to toe-in of the of the steering axle).

Together with said forces, the tilting devices rely also on geometrical and physical features of the vehicle's parts which have a relevant role on improving driveability and maneuverability. For instance, when the tilt axis incidence is substantially null, the effect of the components of the reaction forces normal to the ground (Rn) can prevail on the effect of the component parallel to the ground (Rp), whilst, when increasing the tilt axis incidence, the effect of the component parallel to the ground can overcome the effect of the component normal to the ground.

Since geometrical and physical features are easily measured, they can be taken into account usefully in a first-level classification of the tilting devices, together with the forces.

To identify such measurable features suitable to said classification, some further considerations can be made:
a) the ability to change the angular momentum of the tilting vehicle around its tilting axis increases with the ability to convert the reaction forces at the wheels' footprints, into moments around said vehicle tilt axis;
b) the principle of virtual works suggests that, among the external forces, the components of the reaction forces parallel to the ground and are markedly effective in changing the momentum of the free tilting vehicles, the greater is the tilt gain, that is the ratio between the differential movement of the footprints and the corresponding change in the tilt angle;
c) the reaction forces parallel to the ground are mostly due to the friction at the footprints between the ground and the wheels, or the like: when the vehicle is stopped, these external friction forces at the footprints can be generated by braking the wheels, or the like, so that, by means of the tilting device they can produce a moment around the vehicle tilt axis that can counteract an opposite moment.

What arises is that:
a) the tilting devices of the free tilting vehicles can be effectively classified, at a first level, by keeping apart the family of the tilting vehicles with a tilting axis incidence substantially null;
b) the remaining large families include those tilting devices that, when said gains and external friction forces are great enough, can produce a moment around the vehicle's tilt axis suitable to effectively prevent the sideways fall of the free tilting vehicles when stopped; in other words, according to the classification of the stand devices, a group of tilting devices that can act as stand devices is identifiable which can work by means of said external friction forces (ExFr) only: definitely this group does exist and can be identified by means of criteria based on suitable gains and on geometrical and physical features, within a range unknown to the prior art. These devices will be hereinafter named “tilt/stand devices”.

To identify said tilt/stand devices, a further classification is carried out on the basis of the effectiveness of a stand device as a discriminating feature of the devices as hereinafter claimed.

To this end, a commonly accepted index of effectiveness, suggested by a stand device as popular as the motorcycles' center stand, is the maximum parking slope (mps %), that is the maximum cross slope of a ground, sturdy and rough as tarmac or the like, over which a free tilting vehicle can be parked, perpendicularly to said ground and crosswise said slope, to the limit of its sideways fall.

As a term of comparison, it is expected by a significant number of drivers that the motorcycles' center stand be able to prevent the sideways fall of the motorcycle when it is parked perpendicular to the ground paved with tarmac and across a maximum parking slope which can be assessed, in a first approximation, as mps %=15

On these basis, the value mpsl %=15 has been taken as the lower limit in including a tilt/stand device within the group of devices as hereinafter claimed.

It is known that to satisfy this requirement, the center stands has to be large in proportion to the height of the centre of mass and according to its longitudinal position between the centre stand and the opposite wheel's footprint relative to the wheelbase.

Similarly, to extend said criterion of classification to the tilting three and four wheelers, their maximum parking slope can be estimated on the basis of suitable geometric parameters and physical and kinematic properties of the free tilting vehicles and of the tilting devices. Referring to the devices as hereinafter claimed, said features should include at least: the number of effective tilt/stand devices (nd) implemented in each vehicle (one device in tilting three wheelers, one or two devices in tilting four wheelers); the effectiveness of the linkage adopted, as ratio between the footprints movement (deltab) and the vehicle tilt axis rotation (Ro); the incidence of the tilt axis (betaf at the front axle and betar at the rear axle; |betaf| and |betar| as absolute value at the front and rear axle respectively); the vehicle's track (tv) measured at the axle that is connected to the tilting device, front (tf) or rear (tr); the height over the ground of the centre of mass of the vehicle (hg) and the percentage of the total weight that burden the axle connected to the tilting device, front (wf %) or rear (wr %); the wheelbase of the vehicle (wb); a reduction coefficient inversely proportional to the destabilizing effect of the elastic rolling due to some suspensions layout even if the tilting device has been locked, (kpf) at the front, (kpr) at rear, where kpf=kpr=1 when said suspensions do not contribute to the elastic rolling of the vehicle, therefore described as suspensions “in series”); the friction coefficient between the footprints and the ground (fg, where conventionally fg=1 if not otherwise specified).

For instance, referring to a tilting three wheeler with two wheels at the front, all wheels tilting, in a first approximation the principle of virtual work gives mps %=100*tan((fg/hg)/200)*arcsin(tf*wf %*tan(|betaf|*180/pigreco)* (wf %/200)*kpf+tr*wr %*tan(|betar|*180/pigreco)*(wr %/200)*kpr), where it should be mpsl %=15 as the lower limit of the range of the group of tilt/stand devices as hereinafter claimed.

With a steering front axle pivotally connected to the vehicle's chassis, straight or by means of an interposed trailing arm suspension, characterized in that kpf=1, and on a ground sturdy as tarmac or the like such that the friction coefficient is not less than fg=1, it can be written then: mps %=100*tan(arcsin((tf/hg)*(fw %/200) *tan(|betaf|*180/pigreco)), where the limitation mps %>mpsl %=15 is satisfied by triplet of values of tf/hg, betaf, fw %.

Some of these data and the resultant mps % have been listed in the tabulation in FIG. 9 assuming that fw %=50.

Referring to patent U.S. Pat. No. 7,264,251B2 (Piaggio, applicant; Marcacci, inventor) and to the information disclosed by the relative manufacturer (Piaggio MP3 250 and 400 ie, Gilera Fuoco), the measures of tf, hg, betaf substantially give mps %=6 when fw %=50, kpf=1 (front fs locked), fg=1. Referring to patent EP1180476A1 (Doveri Marco, applicant and inventor), to its drawings and to the information disclosed by the relative manufacturer (Peugeot Metropolis 400i) the measures of tf, hg, betaf substantially give mps %=9 when fw %=50, kp=1, fg=1.

These values of mps % are largely lower than mpsl %=15, and the correlated tilting vehicles are largely outside the range of the tilting/stand devices as hereinafter claimed, even in the precautionary assumption that their wheels' suspensions were locked.

And indeed, as a matter of fact, in the free tilting vehicles manufactured up to now, the standing of the known free tilting vehicles has never been performed yet by solely operating the service or parking brakes, but further means had to be added, such as, for instance, the electro mechanical locking of a suitable elements of the tilting device against the vehicle's chassis.

Otherwise in a free tilting three wheeler of proven driveability (shown schematically in FIG. 4), with a front steering axle pivotally connected to a trailing suspension arm and approximately with a nominal tilt axis incidence betaf=30 deg; front track tv=720 mm; height over the ground of the centre of mass of the vehicle hg=420 mm; percentage of the total weight that burden the front axle fw %=50; weelbase wb=1650 mm; suspension in series to the tilting mechanism so that kpf=1; friction coefficient between the footprints and the ground fg=1; then mps %=25, which is undoubtedly much higher than the mps % of all the tilting vehicles of the known prior art.

The tilt axis incidence betaf and betar exerts its influence not only against the stand device, whose effectiveness increases with beta, as proved by the algorithm of mps %, but also on the maneuverability which can be suitably enhanced by increasing beta.

Computational models explain and tests confirm that, lowering the tilt axis incidence below the magnitude betal=20 deg, the effect of betaf and betar on maneuverability becomes increasingly irrelevant.

On these basis, as well as the magnitude mpsl %=15, also betal=20 deg can be taken as lower limit of the range that includes the tilt/stand devices hereinafter claimed, so that both the conditions mps %>mpsl %, betaf and/or betar>betal, have to be satisfied to include an effective tilting device into the range of said tilting-stand devices.

As for the upper limit of the mps % range, even if the principle of virtual work suggests that the effectiveness in standing of the tilt/stand devices increases with the tilt incidence beta, said upper limit is assessed in fact by the required static equilibrium of the tilting vehicle parked perpendicular to the ground, as well as by the decreasing driveability of the free tilting vehicles on ground irregularities when increasing the tilt incidence |betaf| and/or |betar|.

More specifically the static equilibrium, to the limit of the sideways fall of the tilting vehicles parked perpendicular to the ground on a cross slope, substantially imposes respectively to the three and four wheelers mps %<mpsh %=(ft/hg)*fw %/2 and mps %<mpsh %=50*(vt/hg) (where the front and rear track are the same tf=tr).

Moreover, as to the driveability, an increase of the tilt angle Ibetafi and/or petal increases the ratio between the tilt axis moment and the longitudinal footprint contact forces, that is, it increases the connected sensitivity of the tilting vehicle to the ground irregularities and the negative effects of said sensitivity in terms of comfort, precise handling, yaw stability. For these reasons, rather than any upper magnitude of mps %, the measure of the angle |betaf|=|betar|=45 deg can be connected to the upper limit of the range of tilt/stand devices.

Then back to said classification, within the family of tilting devices with |betaf| and |betar| not null, the range of the tilt/stand devices hereinafter claimed can be identified as the range characterized in that the lower limit is stated by the magnitude mpsl%=15 and |betaf1|=20 deg and the upper limit is |betaf|=45 deg and/or |betar|=45 deg.

Within this particular and critical range, unexpectedly to the prior art, the tilting devices hereinafter claimed perform also as stand devices, since they can make the free tilting vehicles stand when stopped by simply keeping the brakes operating. Within this range said tilting devices will be called “tilt/stand devices”.

Outside said range, where 0<mps %<15 and 0<betaf<20 deg, the tilting vehicles are not suitable to enhance the maneuverability nor to stand by braking only and, to avoid the sideways fall, they have to be implemented with specific stand devices; where |betaf|>45 deg and/or |betar|>45 deg the tilting devices can be described as ineffective to the purpose of most of the free tilting vehicles and to the objectives of the claimed devices.

Within said undiscovered range, several technical solutions are possible for the devices as hereinafter claimed, some of which are represented in the annexed drawings.

### Advantages of the Invention Compared to the Prior Art

Compared to the known tilting vehicles, the inventive concept as hereinafter claimed, benefit from the possibilities, among others:
to design effective free tilting vehicles with three or more footprints on the ground and able to maintain the vertical position, when the vehicle is stopped, with the operation of the brakes only and without adding specific stand devices;
to reduce weight and cost and to increase the reliability of the stand and control device form safe life to fail safe and fail secure;
to improve the road holding of the free tilting vehicles also on uneven surfaces and on small obstacles;
to make the electric vehicles with in-wheel motors, apt to easily control the tilting by managing the traction and brake forces at the footprints thus increasing driveability and maneuverability and reducing weight and costs;
to allow a car-like driving positions due to the fair operating space of the front wheels and to the increased driver's room, and consequently to allow lower vehicle's height improving aerodynamic resistance and stability to lateral wind.

Moreover the devices as hereinafter claimed, benefit also from the possibility:
to enable the drivers to manage by themselves the road holding by instinctively forcing the load transfer, between the wheels of the steering axle, by means of foot levers and possible actuators;
to separate easily the effects of the elastic roll from the kinematic tilt, increasing driveability and making it easier to learn driving;

A further advantage is that all the above objectives can be achieved with clean fail safe designs, low weight and costs, higher reliability compared to the known free tilting vehicles.

Some of these advantages are further detailed in the “Description of embodiments”.

### BRIEF DESCRIPTION OF THE DRAWINGS

In the annexed drawings are shown, by way of examples and by no way of limitation, some of the possible effective tilt/stand devices implemented in free tilting vehicles with two front steering wheels characterized by the combinations of parts hereinafter listed:

FIG. 1a is a left-side view of a free tilting three wheeler perpendicular to the ground, with

a rigid steering axle pivotally connected to the vehicle's chassis by means of a pivot with a suitable tilt axis incidence from high-back to low-front, without suspensions, in compliance with claims n. 1, 2, 3, 9, 14.

FIG. 1b is a three quarters view of the foregoing vehicle, tilted by an angle ro=30 deg approximately.

FIG. 1c is a three quarters view of the foregoing vehicle, perpendicular to the ground.

FIG. 2a is a left-side view of a free tilting three wheeler perpendicular to the ground, with

a beam steering axle pivotally connected to the vehicle's chassis by means of pivots with a suitable tilt axis incidence from high-back to low-front, with trailing arm suspensions between said beam steering axle, with foot levers suitably linked to the steering axle, the tilting device being in compliance with claims n. 1, 2, 4, 9, 10, 11, 14.

FIG. 2b is a left side-view of the foregoing vehicle, tilted by an angle ro=30 deg approximately

FIG. 2c is a three quarters view of the foregoing vehicle, perpendicular to the ground.

FIG. 3a is a left-side view of a free tilting three wheeler perpendicular to the ground, with

a transverse beam and arms steering axle pivotally connected to the vehicle's chassis by means of pivots with a suitable tilt axis incidence from high-back to low-front, without suspensions, the tilting device being in compliance with claims n. 1, 2, 4, 9, 14

FIG. 3b is a left side-view of the foregoing vehicle, tilted by an angle ro=30 deg, approximately.

FIG. 3c is a three quarters front and left-side view of the foregoing vehicle perpendicular to the ground.

FIG. 4a is a left-side view of a free tilting three wheeler perpendicular to the ground, with a transverse beam and arms steering axle is pivotally connected to a trailing arm suspension by means of a pivot with a suitable tilt axis incidence from high-back to low-front, said trailing arm being pivotally linked to the vehicle's chassis, with foot levers suitably linked to the steering axle and with actuators apt to the tilting device being in compliance with claims n. 1, 2, 4, 7, 8, 9, 11, 12, 14.

FIG. 4b is a left side-view of the foregoing vehicle, tilted by an angle ro=30 deg, approximately.

FIG. 4c is a three quarters front and left-side view of the foregoing vehicle perpendicular to the ground.

FIG. 5a is a left-side view of a free tilting three wheeler perpendicular to the ground, with a rigid steering beam axle which is rotatably connected, and at the same time suspended, to the chassis of the tilting vehicle by means of a longitudinal rotoreflected double wishbone suspension and tilting device, with a suitable tilt axis incidence from high-back to low-front, with foot levers suitably linked to the steering axle, the tilting device being in compliance with claims n. 1, 2, 6, 8, 9, 11, 14.

FIG. 5b is a left side-view of the foregoing vehicle, tilted by an angle ro=30 deg, approximately.

FIG. 5c is a three quarters front and left-side view of the foregoing vehicle perpendicular to the ground.

FIG. 6a is a left-side view of a free tilting three wheeler perpendicular to the ground, with a transverse beam and arms linkage which is rotatably connected, and at the same time suspended, to the chassis of the tilting vehicle by means of a longitudinal rotoreflected double wishbone suspension, with a suitable tilt axis incidence from high-back to low-front, with foot levers suitably linked to the steering axle, the tilting device being in compliance with claims n. 1, 2, 7, 8, 9, 11, 14.

FIG. 6b is a left side-view of the foregoing vehicle, tilted by an angle ro=30 deg, approximately.

FIG. 6c is a three quarters front and left-side view of the foregoing vehicle perpendicular to the ground.

FIG. 7a is a three quarters front and left-side view of a tilting sled with three tilting skis, with

a transverse beam and arms steering axle pivotally connected to the vehicle's chassis by means of pivots with a suitable tilt axis incidence from high-back to low-front, without suspensions, the tilting device being in compliance with claims n. 1, 2, 4, 9, 14.

FIG. 8a is a three quarters left-side view of the rotoreflected double wishbone tilting and suspension device of the free tilting vehicle according to FIG. 5a, 5b, 5c, perpendicular to the ground.

FIG. 8b is a three quarters left-side view of said rotoreflected double wishbone tilting and suspension device, tilted by an angle ro=30 deg;

FIG. 9 is the summary chart of prior art whose contents are detailed in the paragraphs of the Background art

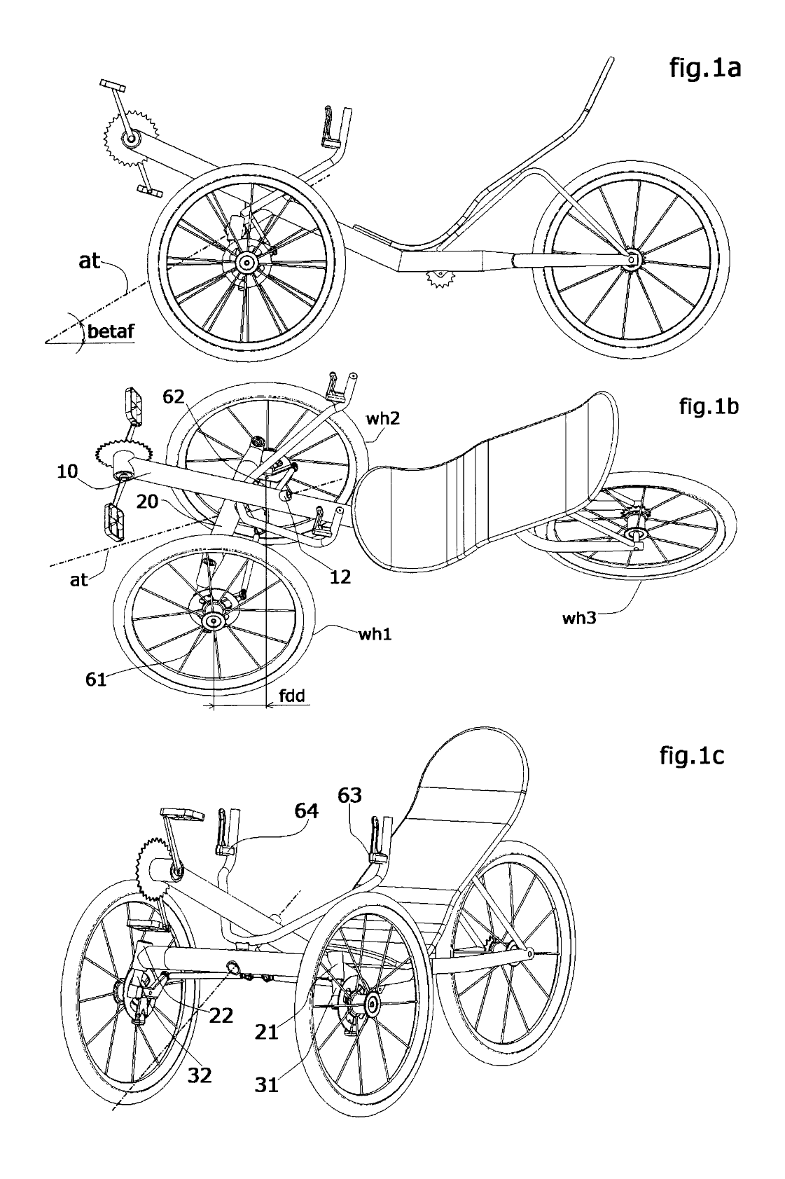

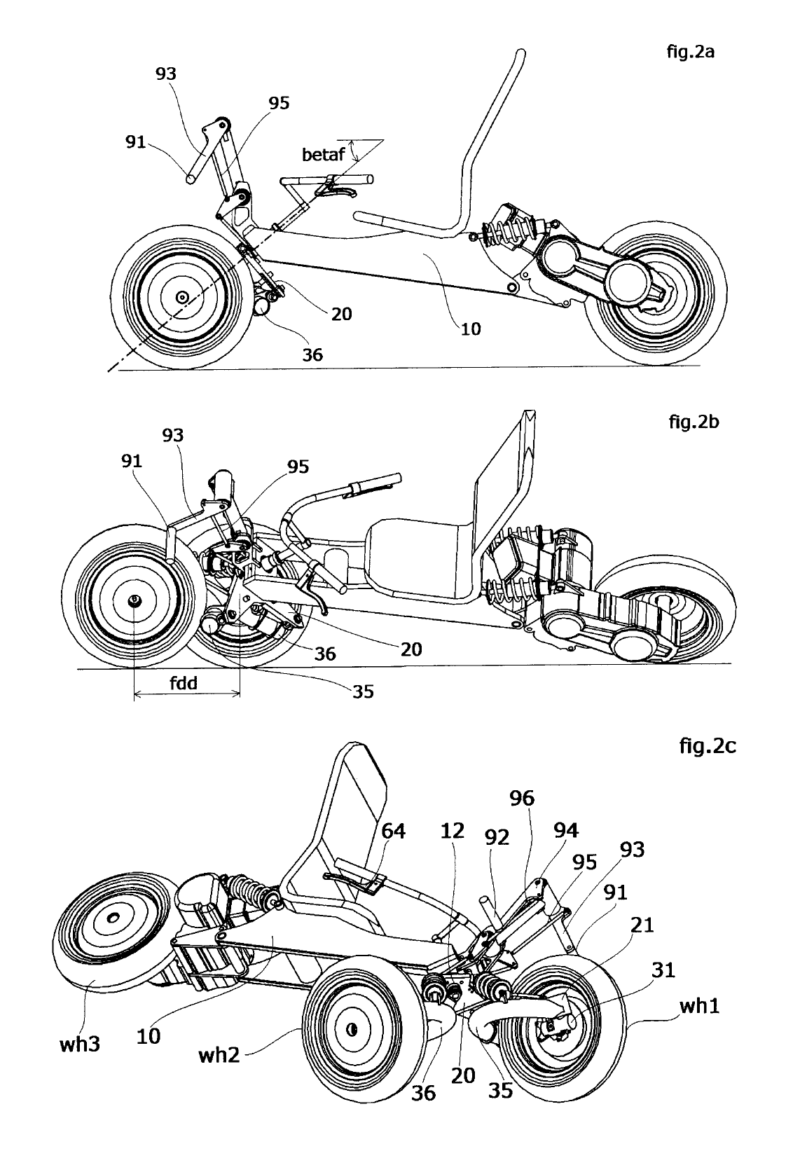

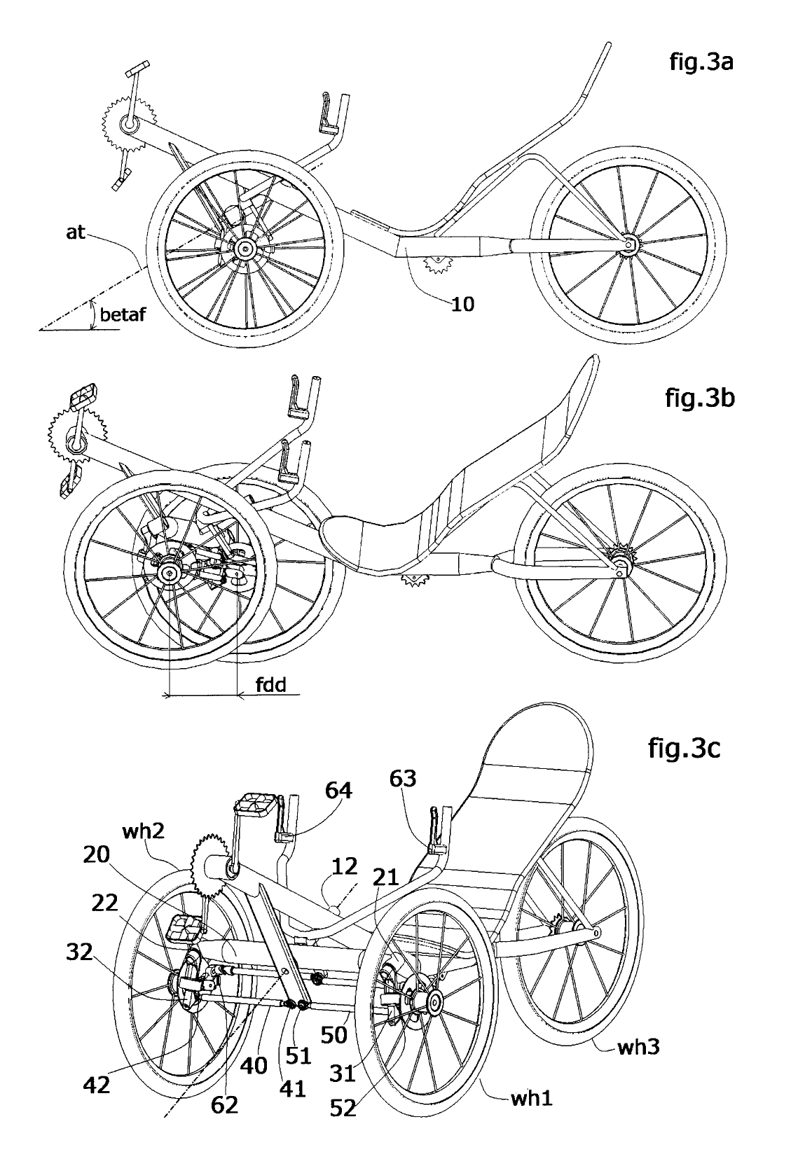

### DESCRIPTION OF EMBODIMENTS

Hereinafter, some embodiments of the devices as hereinafter claimed will be described with reference to the accompanying drawings, by way of an example and by no way of limitation since the inventive concept can be similarly applied to other embodiments by a suitable design and combination of alike parts.

### Description of a First Embodiment

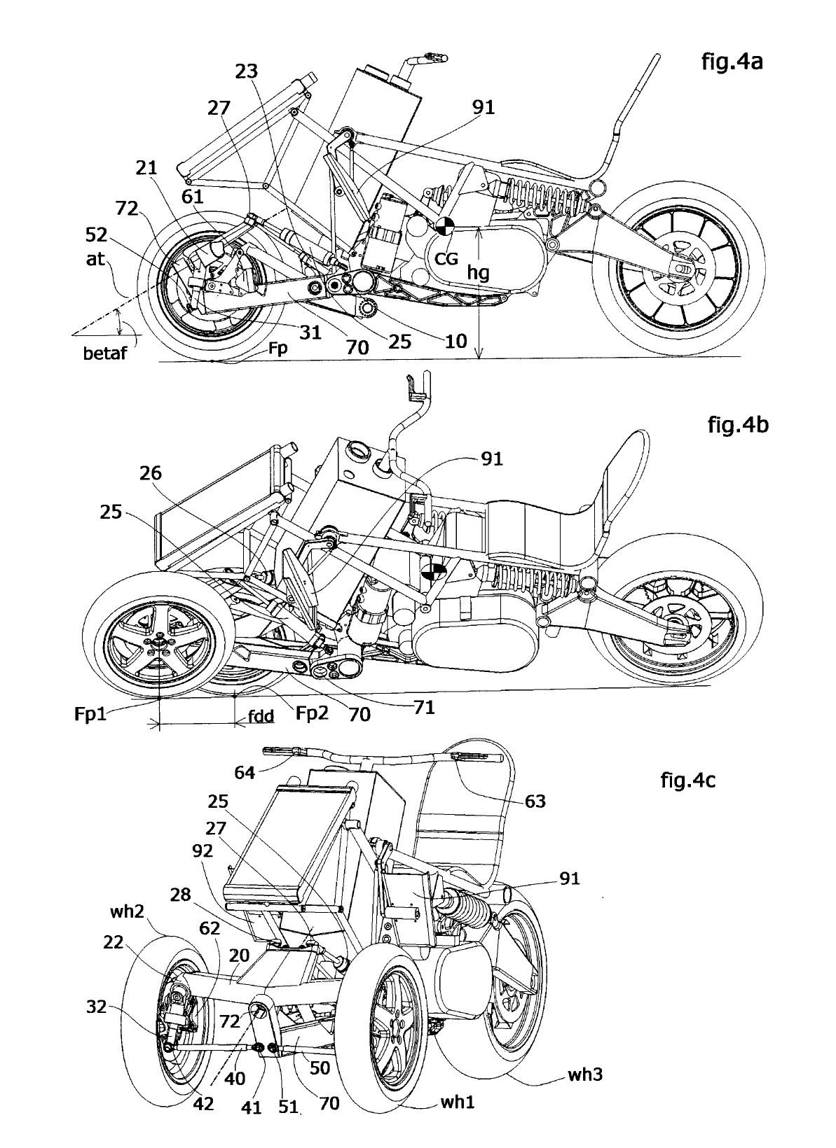

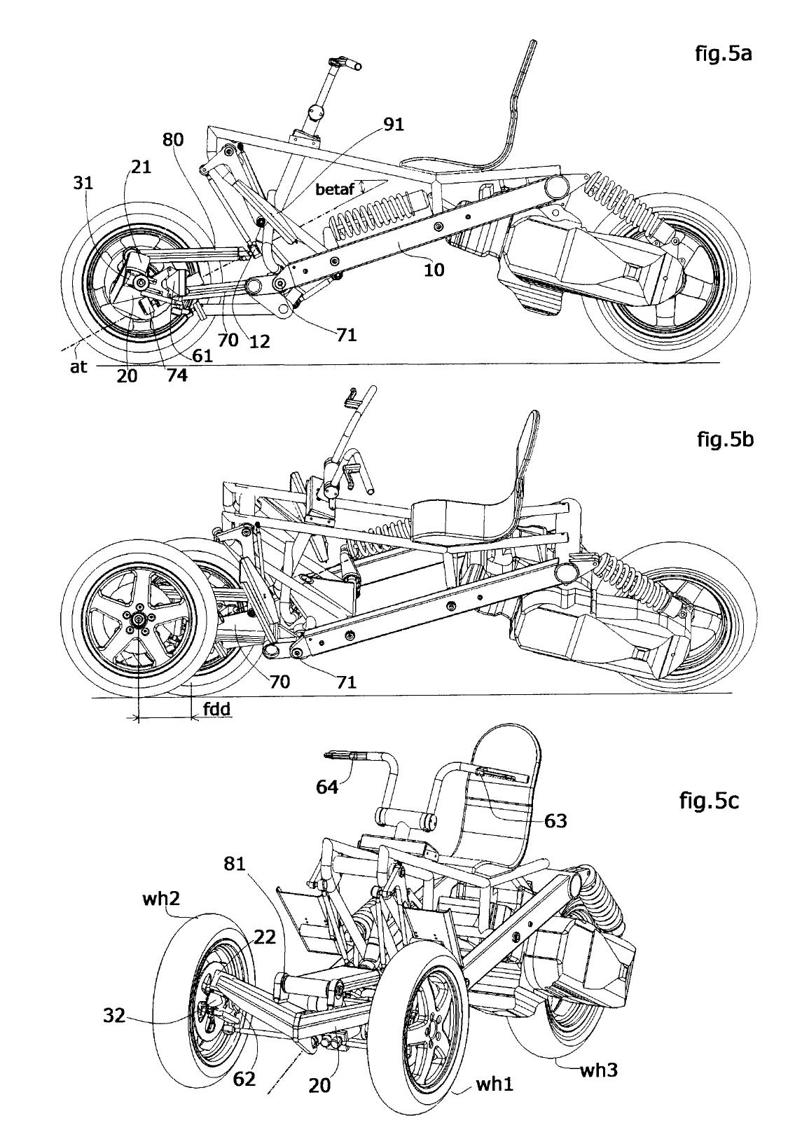

In FIG. 4a, 4b, 4c, the inventive concept is applied to a free tilting road vehicle with three wheels (wh1, wh2, wh3), all the wheels being tilting with the vehicle. The tilting device has a transverse beam (20) and arms (40, 50) steering axle, all pivotally or rotatably connected to a trailing arm suspension (70). More specifically the transverse beam (20) is pivotally connected to the trailing arm (70) by means of pivot (72) with a suitable tilt axis incidence (betaf) from high-back to low-front and with the tilt axis (at) lying on the vehicle's symmetry plane, whilst the arms (40, 50) are rotatably connected to the trailing arm (70) by means of spherical pairs (41, 51). Furthermore the trailing arm is pivotally linked to the vehicle's chassis (10) by means of a couple of coaxial pivots (71, 72) perpendicular to the vehicle's symmetry plane.

FIG. 4a is the left-side views of said vehicle perpendicular to the ground and without the left wheel (wh1) to expose the tilting device. FIG. 4b is the left-side views of said vehicle perpendicular to the ground and tilted by an angle ro=30 deg, approximately. FIG. 4c is a left-side three quarters front view of said vehicle when perpendicular to the ground.

More in detail the transverse beam (20) acts as an upper cross rocker arm common to a double symmetrical four bar linkage system where the steering knuckles (31, 32) behave as opposite coupler links pivotally connected to the ends (21,22) of the transverse beam (20) and rotatably connected to the ends (42,52) of the two opposite transverse arms (40, 50), the rocker arm (20) of said steering axle being suitably pivotally connected by means of a pivot (72) to a trailing arm suspension (70), also the two opposite transverse arms (40, 50) being rotatably connected by means of spherical pairs (41,51) to trailing arm suspension (70), which is interposed between said rocker arm (20) and the vehicle's chassis (10).

The transverse beam (20) is the part that transfers the bumps from the road to the trailing arm (50) which reduce the stress to the chassis (10). In this specific and limited example, the transverse beam (20) receives also, from the actuators (25,26) and by means of the spherical pairs (27,28), the stress controlled by the driver by means of foot levers (91,92) with sensors (23,24 hidden).

Referring to the classification criterion previously described, being betaf=30 deg, this tilting vehicle belongs to the family of free-tilting vehicles with the tilt axis incidence not null Moreover within this family the magnitude of mps % as previously introduced is given by the followings vehicle's data: the suspension is such that, when the tilting is locked, the wheels of the steering axle cannot move independently, relative to the chassis (suspension in series to the tilting device), so that kpf=1; tilt axis (at) incidence is betaf=30 deg, friction coefficient fg=1, weight percentage at the front axle wf %=50, betaf=30 deg, tf=720 mm, hg=420 mm. Therefore mps%=100* tan((fg/hg)/200)*arcsin(tf*wf %*tan(|Betaf|*180/pigreco)*(wf %/200)*kpf)=25 approximately, higher than the discriminating magnitude mpsl %=15. The device belongs then to the group of the tilting/stand devices as hereinafter claimed, that is to the tilting devices that can act as stand devices when the vehicle is stopped, without extra parts.

More specifically it complies with claims 1, 2, 4, 5, 7, 8, 9, 11, 12, 14.

In drawing 4a and 4b is shown a left-side view of said vehicle respectively perpendicular to the ground and tilted by an angle ro=30 deg, approximately, with the tilt axis incidence from high-back to low-front. Comparing drawings 4a and 4b, it is noticeable the connection between the tilt angle and the forward movement of the left wheel (wh1) and the rearward movement of the right wheel (wh2), which bring the differential longitudinal movement fdd of the footprints (Fp1,Fp2). Said differential movement, which is consistent with the tilt axis incidence betaf=30 deg, looks much relevant compared to the known art, even more if compared to the correlative small lowering of the centre of mass from its initial height (hg) over the ground. Similarly the derivative dfdd/dro is relevant too.

Compared to the prior art, such a relevant forward movement of the inner wheel when the vehicle tilts on the left has the advantages previously listed. Some of these advantages are hereinafter detailed.

As for the possibility to improve the roadholding on uneven surfaces and on small obstacles, the following considerations are proposed: in prior art, when a left or right wheel (wh1, wh2) unexpectedly hits a small obstacle, the bump against the wheel, can cause a sudden left yaw.

Unlike the prior art, the tilting devices here embodied surely reduce the ensuing risk of a fall. Indeed in said devices a bump against a left or right wheel cause a change in momentum of the parts which are linked to the hit wheel by means of the tilting device, included the chassis (10) which is forced to rotate to the opposite side, with a stabilizing effect on the vehicles trajectory. Moreover the caused angular impulse of the chassis to the side opposite to the bump, implies a momentary increase in the component of the reaction force (Rn) normal to the ground at the footprint (Fp) of the hit wheel, which improves the roadholding.

A second advantage of said forward movement of the inner wheel and rearward movement of the outer wheel, which is due to the relevant tilt angle and to the tilt axis incidence from high-back to low-front, is that the triangle formed by the footprints' centres is more in favour of the lateral stability than the triangle formed when the tilt axis incidence is, conversely, from low-back to high-front, as in prior art.

A third advantage of said forward movement of the inner wheel is that indeed, when tilting, the inner wheel moves towards high-forward, and the outer wheel towards low-rearward, so that, on equal wheelbase, the maneuvering space increases for the driver. This solution allows for tilting vehicles as long as a motorcycle but with a driver's feet forward posture. It follows that free tilting vehicles can be designed which are lower, with a lower aerodynamic resistance, improved stability on lateral wind, lower gravity centre and therefore improved maneuverability compared to the prior art.

A fourth dependent advantage is that, on a feet-forward posture the driver can easily and effectively operate foot levers (91,92). Then, with a simple linkage is possible to connect the foot levers to the transverse beam (20) so that, by pushing on said footlevers, the driver can apply a moment around the tilt axis (at). With this manoeuvre the driver can voluntary transfer, while driving, some of the vertical load between the wheels, for instance from the outer wheel to the inner, and manage therefore the attitude of the vehicle, particularly when loosing grip while cornering.

To enhance this effect, in this specific and limited example the transverse beam (20) can be stressed with a suitable moment around the tilt axis, generated by the actuators (25, 26) and exerted by means of the spherical pairs (27, 28), the stress being controlled by the driver by means of a suitable control system which includes foot levers (91, 92) and sensors (23, 24 hidden).

A fifth advantage is that all this can be achieved without increasing but rather reducing the complexity, that is the risk of failures, of the known tilting and stand devices.

For instance, since the stand systems that brake or lock semiautomatically or automatically the tilting device are made of mechanical and/or hydraulic, electrical and electronics parts, many of which have necessarily a “safe life” reliability, therefore, in the absence of maintenance, the failure of some element of said parts is unavoidable. This event is unacceptably dangerous, it can happen without warning signals unlike, for example, a worn-out brake, and might suddenly lock a tilting device so that a tilting vehicle could no longer tilt or recover from a tilt, preventing the dynamic equilibrium while driving.

Conversely in a vehicle braking system, a malfunction that locks a brake makes the vehicle stop or just prevents the drive, whilst when a brake fails another brake can be actuated. That is a malfunction of brakes do not cause danger to the safety of people. In other words the brake systems, as well as the tilting/stand devices hereinafter claimed, are “fail-safe” devices.

### Description of a Second Embodiment

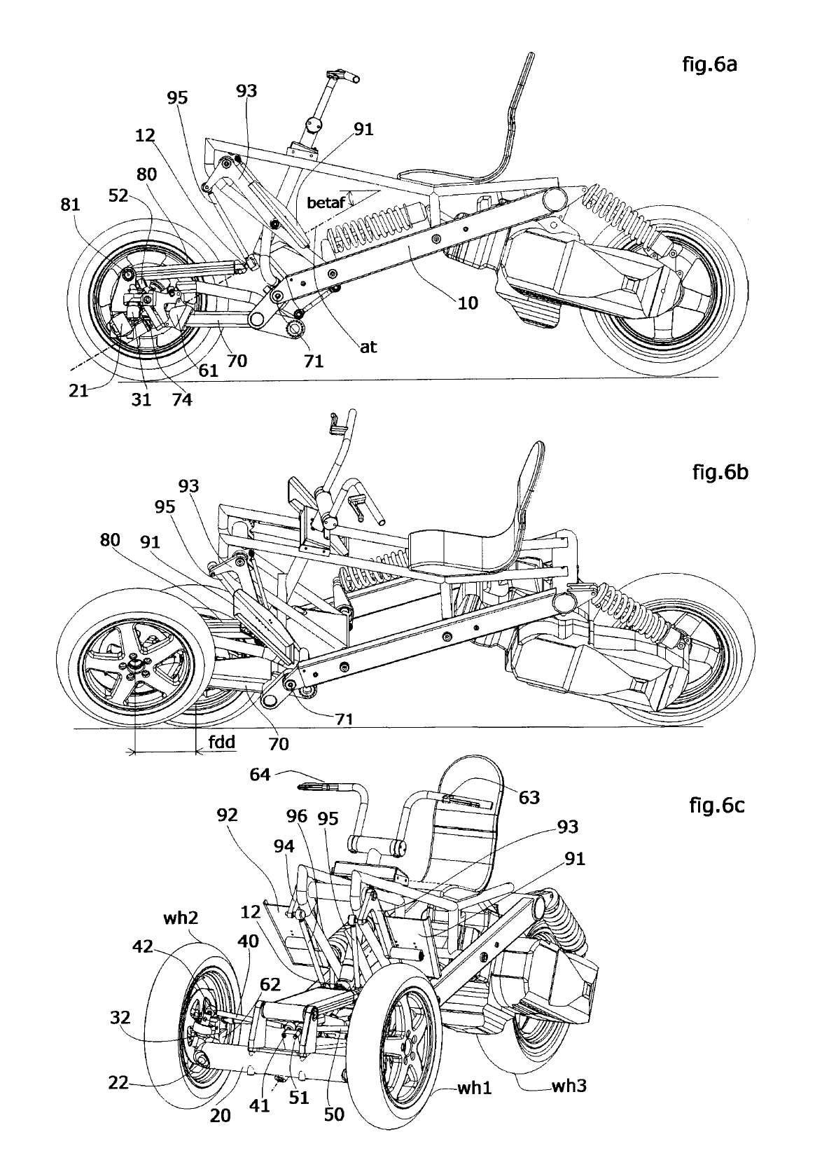

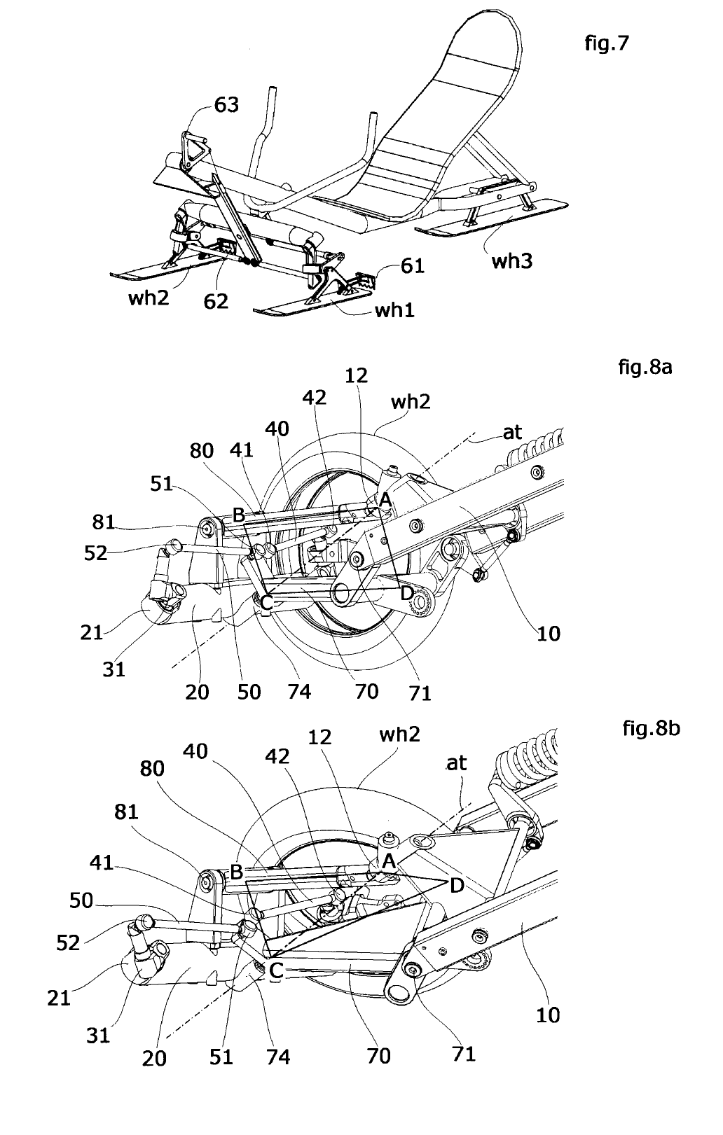

FIG. 6a is a left-side view of a free tilting three wheeler perpendicular to the ground, with a transverse beam and arms linkage which is rotatably connected, and at the same time suspended, to the chassis (10) of the tilting vehicle by means of a longitudinal rotoreflected double wishbone suspension (70, 20, 80), hereinafter called “longitudinal tilting suspension”.

In FIG. 6a the tilt axis is identifiable as the line between the spherical pairs (12) and (74), inclined from high-back to low-front.

FIG. 6b is a left side-view of the same vehicle, tilted by an angle ro=30 deg, approximately, where the tilting of the lower arm of said suspension (70) can be seen.

FIG. 6c is a three quarters front and left-side view of the same vehicle perpendicular to the ground where the transverse beam and arms steering axle is identifiable.

Said transverse beam and arm linkage is equivalent to the homonymous linkage described in the first embodiment from which it substantially differs only in having the transverse beam (20) on the lower side of the double four-bar linkage and the two opposite transverse arms (40, 50) on the upper side. Therefore the linkage will not be further described.

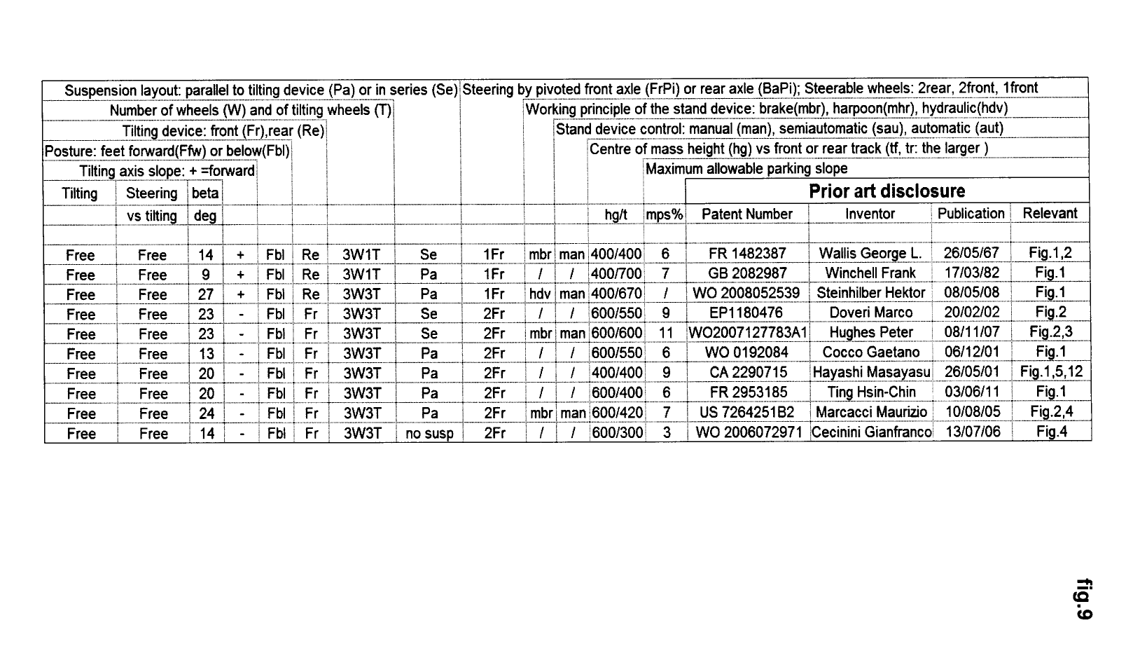

The longitudinal tilting suspension is shown more clearly in FIGS. 8a and 8b where it is identifiable as a spatial four-bar linkage with two degrees of freedom, one used by the suspension, the other one by the tilting.

The function of suspension only is noticeable in FIG. 8a with the vehicle perpendicular to the ground: AD is the fixed link of the four-bar linkage, that is the chassis (10); AB and CD are the grounded links, that is, respectively, the upper arm (80) and the lower arm (70); BC is the coupler, that is the transverse rocker beam (20) of the steering beam. The function of tilting device is noticeable in FIG. 8b with the vehicle tilted leftside of 30 deg around AC, which is the tilt axis (at). What clearly arise from drawings is that the triangle ACD (where AC is the tilt axis, CD belong to the suspension lower arm, AD to the chassis) is rotated anticlockwise around the tilt axis AC compared to the triangle ABC of the four-bar linkage ABCD identifiable when said tilting vehicle is perpendicular to the ground.

From a kinematic point of view It is known that a plane four-bar linkage suspension requires four revolute pairs, while a steering four-bar linkage, that is a double wishbone suspension, requires two revolute pairs on the frame side and two spherical pairs on the steerable wheel side.

Dissimilarly, the four-bar linkage belonging to the longitudinal tilting suspension (ABCD), is characterized in that the pairs (A, B) substantially repeat, rotoreflectively, the pairs of the lower wishbone (D, C), in a way that, compared to the known double wishbone linkage, the revolute pair (A) is exchanged with the spherical pair, and the spherical pair (B) is exchanged with the revolute pair. In other words, from the geometric point of view, the pairs (A, B) are the result of a combination of a rotation about an axis and a reflection in a plane perpendicular to that axis, whilst the other four-bar linkage suspensions are the result of a sole reflection about an axis parallel to the plane of the linkage.

From a functional point of view, the plane four-bar linkage can act only as a suspension device, the double wishbones as a suspension and steering device, and only the longitudinal tilting suspension can act as suspension and tilting device.

The differences from a kinematic, geometric and functional point of view, testify that this first embodiment of the device hereinafter claimed has no analogy with the four-bar linkages suspensions as known so far.

By way of an example and by no way of limitation, the longitudinal tilting suspension can be made as in drawings 6a, 6b, 6c, 8a, 8b providing: a lower arm (70), wishbone shaped, pivotally connected by means of pivots (71,72) to the chassis (10), and by means of a ball joint (74) to the rocker arm (20) of a front transverse double four-bar steering axle, rocker which acts as coupler; an upper arm (80) rotatably connected to the chassis (10) on the vehicle's symmetry plane by means of a second ball joint (14), and pivotally connected to said rocker arm (20) by means of a pivot (81); a coupler coincident with the rocker arm (20) which bears the lower ball joint (14) and the higher pivot (81), so connecting the transverse beam (20) and arms (40, 50) steering axle to the tilting/suspension device.

The drawings point out also the left and right foot control (91,92) which are linked to the upper arm (80) by means of rockers (93, 94) and rods (95,06).

The advantages of this second embodiment over the prior art are the same of the claimed inventive concept, as detailed in the first embodiment. More specifically this second embodiment, compared to the first one, discloses a longitudinal tilting/suspension system that, being, from kinematics, a four-bar linkage with an instant center of rotation of the coupler that can be easily defined, encourages the best setting of the front suspension dynamic behavior.

This second embodiment complies with claims n. 1, 2, 4, 8, 9, 11, 14.

### INDUSTRIAL APPLICABILITY

As can be inferred from the claimed devices and as was tested, the inventive concept claimed hereinafter, can give useful, concrete and tangible result mostly in the area of light vehicles where the interest of motorcycles' industry has recently grown, and where a significant number of scooter-like tilting three wheelers have already been produced.

Indeed, comparing to the background art, the tilting/stand devices hereinafter claimed can reduce the manufacturing costs, increase reliability, safeness and driveability of the free tilting vehicles. Moreover since the prevailing layout of the claimed devices encourage new driving postures, new markets can be profitably explored.

Hence, said tilting/stand devices can easily and surely find an industrial application.

1. Tilting devices, particularly suitable for the tilting vehicles that are free to lean, that are also free to be steered at the front axle, and that leave on the ground at least three not aligned footprints, apt to let said tilting vehicles lean when driving and to keep them standing when stopped, and characterized in that, any change in the lean angle of said tilting vehicles brings about a biunique longitudinal differential movement of at least two footprints, said differential movement being significant in direction and magnitude so that the sideways fall of said vehicles, when they are parked perpendicular to the ground and crosswise a slope of at least 15%, can be prevented by means of the friction forces transmitted from the ground to said vehicles through said footprints, for instance where the vehicles' brakes, or the like, are operated.

2. Tilting mechanisms according to claim 1, characterized in that said differential movement of said footprints is achieved by means of one suitable steering axle at the front or one at the rear of the tilting vehicle, or two suitable steering axles one at the front and one at the rear of the tilting vehicle, said steering axles being characterized in that, at each end, one or more steerable wheels, or endless tracks, snow skis, ice skates, or the like, are pivotally connected by means of knuckles in a way that, where the steering axle is at the front of the tilting vehicle, said steerable wheels, or the like, are free to be steered, whilst, where the steering axle is at the rear of the tilting vehicle, the steering of said steerable wheels, or the like, is linked to the vehicle's chassis by the means specified in the following claim 13, said steering axles being rotatably connected to the chassis of the tilting vehicle or to a suspension interposed between said steering axle and the vehicle's chassis, so that the physical or kinematically equivalent axis of rotation of said steering axles, that is the tilt axis, is substantially on the symmetry plane of said tilting vehicle, suitably inclined over the ground of an angle betaf at the front axle and betar at the rear axle in compliance with the conditions set in the following claim 14, said tilt axis being common to the steering axle and to the chassis (missing the suspension), or to the chassis and the suspension, or to the suspension and the steering axle.

3. Tilting mechanisms according to claim 2, characterized in that said steering axle is, from a kinematic point of view, a transverse beam, substantially reflectively symmetric to the symmetry plane of the vehicle, wherein the steering knuckles are pivotally connected to the ends of said transverse beam which is itself pivotally connected to the chassis of the tilting vehicle or to a suspension interposed between said steering axle and the vehicle's chassis.

4. Tilting mechanisms according to claim 2, characterized in that said steering axle is, from a kinematic point of view, a transverse beam and arms linkage, substantially reflectively symmetric to the symmetry plane of the tilting vehicle, wherein the transverse beam works as a cross rocker common to a double symmetrical four bar linkage system and where the steering knuckles behave as opposite coupler links connecting the ends of the transverse beam and of the two opposite transverse arms, said steering axle being suitably rotatably connected to the chassis of the tilting vehicle or to a suspension interposed between said steering axle and the vehicle's chassis.

5. Tilting mechanisms according to claim 2, characterized in that said steering axle is, from a kinematic point of view, a transverse double arm linkage, substantially reflectively symmetric to the symmetry plane of the vehicle, wherein, on each side of said symmetry plane, the steering knuckles behave as coupler links between the outer ends of two transverse arms which, one upper and one lower, complete the relative four-bar linkage, each arm being pivotally connected to the chassis of said vehicle by means of pivots, or the like, which are suitably inclined towards the ground of said angle betaf at the front axle and betar at the rear axle in compliance with the conditions set in the following claim 14, the two symmetrical upper or the two symmetrical lower transverse arms being connected to each other by resilient means, directly or through a suitable linkage.

6. Tilting mechanisms according to claim 2, characterized in that the differential movements of said footprints are achieved by means of a steering beam axle which is rotatably connected, and at the same time suspended, to the chassis of the tilting vehicle by means of a longitudinal rotoreflected double wishbone suspension, said suspension being characterized in that the lower longitudinal arm is rotatably connected at its apex to said steering beam axle by means of a spherical pair and, on the opposite side, it is pivotally connected to the vehicle's chassis by means of a pivot, or the like, which is perpendicular to the vehicle's symmetry plane, whilst the upper arm, rotoreflectively to the lower arm, is pivotally connected to the steering beam axle by means of a pivot, or the like, which is parallel to said steering beam axle, and is rotatably connected to the vehicle's chassis, on its symmetry plane, by means of a second spherical pair, the two spherical pairs and the two pivots, or the like, of the longitudinal rotoreflected double wishbone suspension being arranged so that that the lower arm, the beam axle and the upper arm are the three moving bars of a longitudinal four bar spatial linkage which is characterized in that the chassis is the grounded link which, as well as the lower arm, lies on the symmetry plane of the vehicle, whilst the coupler link, which is bodily connected to the beam axle, and the upper arm, lie on the symmetry plane of said steering axle and are free to rotate around the axis which connects said spherical pairs, that is around the tilt axis, said tilt axis being suitably inclined towards the ground of said angle betaf at the front axle and betar at the rear axle in compliance with the conditions set in the following claim 14.

7. Tilting mechanisms according to claim 6, characterized in that, in vice of the steering beam axle, a steering axle is implemented which, from a kinematic point of view, is a transverse beam and arms linkage, substantially reflectively symmetric to the symmetry plane of the tilting vehicle, wherein the transverse beam works as a cross rocker common to a double symmetrical four bar linkage system where the steering knuckles behave as coupler links between the ends of the transverse beam and of the two opposite transverse arms, said steering axle being suitably rotatably connected to said longitudinal rotoreflected double wishbone suspension, by means of pivots, or the like, which are parallel to the symmetry plane of the tilting vehicle and inclined towards the ground of said angle betaf at the front axle and betar at the rear axle in compliance with the conditions set in the following claim 14.

8. Tilting mechanisms according to one or more of the preceding claims, characterized in that the possible suspensions of said tilting vehicles, from a kinematic point of view, do not contribute to the elastic rolling of said tilting vehicle when the tilting is prevented.

9. Tilting mechanisms at the front axle according to one or more of the preceding claims, characterized in that the inclination over the ground of the tilt axis is from rear-high to front-low.

10. Tilting mechanisms at the rear axle according to one or more of the preceding claims, characterized in that the inclination over the ground of the tilt axis is from rear-low to front-high.

11. Tilting mechanisms according to one or more of the preceding claims, characterized in that the driver, by means of foot levers suitably linked to the steering axle, can force a load transfer between the footprints connected to the tilting axle, to voluntarily affect the road holding or/and the tilting.

12. Tilting mechanisms according to claim 11, characterized in that the action of the driver on the pedals can be amplified by means of actuators apt to generate a moment around the tilt axis proportional to the differential push by the driver's feet

13. Tilting mechanisms according to one or more of the preceding claims, characterized in that, where the steering axle is at the rear of the tilting vehicle, the steering of the rear steerable wheels or the like is suitably linked to the vehicle's chassis by means of a linkage characterized in that, any change in the lean angle of said tilting vehicles brings about a biunique steering of said rear steerable wheels relative to the steering axle such that said wheels are substantially not steered with respect to the symmetry plane of said tilting vehicle, or they are steered only to improve the stability of said tilting vehicle while leaning.

14. Tilting mechanisms according to one or more of the preceding claims, characterized in that they comply with both the conditions: betaf or/and betar >betal=20 deg and mps %=100*tan((fg/hg)/200)*arcsin(tf*wf % *tan(|betaf|*180/pigreco)* (wf %/200)*kpf+tr*wr %*tan(|betar|*180/pigreco)*(wr %/200)*kpr)>mpsl %=15, where “fg” is the friction coefficient of the wheels on the ground, and “hg” is the height of the centre of mass of the vehicle over the ground, and where, respectively at the front and at the rear axle: “|betaf|” and “|betar|” are the absolute values of the tilt axis incidences, “tf” and “tr” are the tracks which are null when the axle has one wheel only; “wf %” and “wr %”is the % of the vehicle's total weight that burden the front and rear axle respectively; “kpf” and “kpr” are coefficients whose value, between 0 and 1, is inversely proportional to the destabilizing effect of the elastic roll due to the suspensions of the respective axles when said suspensions can contribute to the elastic rolling of the vehicle where the tilting has been locked.
